(19) United States
(12) Patent Application Publication
(10) Pub. No.: US 2025/0252466 A1
(43) Pub. Date: Aug. 7, 2025

(54) COMPUTER-IMPLEMENTED METHODS FOR AN INTEGRATED CONTROL SYSTEM FOR PROVIDING A RESPONSE TO A USER QUERY

(71) Applicant: Supertab AG, Steinhausen (CH)

(72) Inventor: Cosmin-Gabriel Ene, Zollikon (CH)

(21) Appl. No.: 19/041,258

(22) Filed: Jan. 30, 2025

(30) Foreign Application Priority Data
Feb. 1, 2024 (IE) S2024/0078

(51) Int. Cl. G06Q 30/0283; G06F 16/332; G06Q 30/0207

(52) U.S. Cl. CPC G06Q 30/0283; G06F 16/3326; G06Q 30/0207

(57) ABSTRACT

Computer-implemented methods for integrated control systems for providing responses to a user queries comprises the steps of: receiving a user query from a user by an integrated control system; generating a pricing request based on the user query and/or parameters attached to the user; transmitting the pricing request to a large language model, wherein the integrated control system requests the large language model to generate a price indication; receiving by the integrated control system the price indication generated by the large language model; determining based on the price indication a response price; requesting confirmation from the user to allocate the response price; receiving by the integrated control system a confirmation to allocate the response price; allocating the response price using a payment system; and transmitting a response associated with the user query to the user.

### CROSS-REFERENCE TO RELATED APPLICATION

This application claims priority under 35 U.S.C. § 119 from Irish Patent Application No. S2024/0078, filed Feb. 1, 2024, which is hereby incorporated by reference in its entirety herein.

### FIELD OF THE INVENTION

The present application relates to computer-implemented methods for integrated control systems for providing responses to user queries.

### BACKGROUND

The growing usage of modern chatbot systems, particularly those based on generative artificial intelligence (AI) models, such as the Chat Generative Pre-trained

Transformer (ChatGPT), has prompted the continuous refinement of these chatbots in order to enhance their capabilities and optimize the user experience.

Generative AI models that employ AI techniques to comprehend and process human language text and generate human-like responses to user queries and inputs are generally known as Large Language Models (LLMs). With the ongoing progress of technology, the increased need for generative AI based on LLMs to extend beyond text-based interactions has led to the research, development and integration of multimodal features, allowing the users to interact with the generative AI also through an audio or video input. To achieve this, generative AI tools commonly utilize an LLM in combination with speech-to-text conversion models that are capable of converting the audio or the video's audio into text. To develop these functionalities, LLMs are trained on substantial amount of text, audio and video data, which requires considerable computational capacity and energy consumption that are expected to increase further over time. Alongside the environmental impact of LLMs, the increased preferences and expectations of users for improved quality, usefulness and personalization of the generated responses, have triggered the search for solutions to make the LLMs more economically viable, helpful and tailored to users.

Typically, LLMs operate without access to personal user information and the responses they generate are not automatically customized to individual needs and preferences. Consequently, for the LLM to produce a more personalized response, the users are required to explicitly include all pertinent information in their queries which can be perceived as counterproductive by the users, lead to potential user frustration or have a limiting effect on the quality of the provided response. Specifically, attributes that can potentially improve the response quality may not be considered by the users.

The quality of a generated LLM response may be influenced by various factors, including the quality of the query or input, the quantity and diversity of the data used for training the model, and how relevant that data is with respect to the query or input. Furthermore, training data, if not carefully preprocessed, may likely lead to the LLM learning incorrect information, showing biased behavior or experiencing what is known as AI hallucinations.

Further, some LLMs operate with data collected from publicly available sources and do not use information from proprietary internet pages, real-time data or specific databases that often require payment or subscription for access. Typically, access to these LLMs is unrestricted. In general, an unrestricted utilization of an LLM may lead to excessive or irresponsible use of its computational resources, further contributing to the environmental footprint.

LLMs can also be trained on data that includes copyrighted material and/or may require payment for generating responses to user queries. In general, a paid use of an LLM can offer various benefits, including improved service, advancements in functionality and continuous system development. Furthermore, a generated revenue may be invested, for example, in clean energy sources for powering the data centers that host the LLMs. Payment based LLMs, such as ChatGPT-4, primarily rely on subscription payments for using the LLMs' capabilities. However, subscription payments are prone to high churn rates or can discourage potential users, seeking more flexibility, from using the LLMs.

In addition, subscription payments are fixed price payments and may be somewhat inequitable considering that different users have different needs and preferences or provide varying levels of detail and complexity to their queries or inputs. This way, a user seeking more straightforward information is charged the same as a person asking a more complex or personalized question. Further, according to reports from AI service providers, there is a huge demand for AI services which in many scenarios exceeds the available hardware resources.

### SUMMARY OF THE INVENTION

It is an objective of the present invention to provide improved methods for integrated control systems for providing responses to user queries. In particular, there is a need to distribute available hardware resources appropriately to improve available service, e.g. to enhance responsiveness.

It is a further objective of the present application to provide an alternative method for charging for a response to a user query generated by a generative AI system.

It is also an objective of the present invention to establish an autonomous and self-assessing method that is user tailored for charging for a response, the method ensuring a seamless and secure user experience.

The present invention solves the aforementioned problems by a method for an integrated control system for providing a response, the method comprising the steps of:
receiving a user query from a user by the integrated control system;
generating a pricing request based on the user query and/or parameters attached to the user;
transmitting the pricing request to a large language model, wherein the integrated control system requests the large language model to generate a price indication, in particular a price;
receiving by the integrated control system the price indication generated by the large language model;
determining based on the price indication a response price;
requesting confirmation from the user to allocate the response price;
receiving by the integrated control system a confirmation to allocate the response price;
allocating the response price, preferably using a payment system; and
transmitting a response, associated with the user query, to the user.

The query stems from a user and may be issued through a client device, for instance a mobile device, personal computer or any other type of digital device. However, it is not necessary that client device is a dedicated hardware assigned to a single user. Indeed it is also possible that the client interacts with the same system that also hosts, at least partly the LLM and/or any other component as set out above.

The user query is commonly a question or a prompt that inquires information or assistance regarding a specific topic and may be provided as text, an image, audio or video data, and/or a combination of these modalities. Correspondingly, the response to the user query may take the form of text, an image, audio/video data or a combination of these modalities. The received user query may be generated, for example, via web interface. Alternatively, the received user query may be generated by any other means, for example, via word processing software like Microsoft Word, a software running in a car, a third-party interface, application programming interface (API), messaging apps or any other type of device or interface.

It is one aspect of the invention, to use generative AI, in particular an LLM to arrive at price indication for a user query which is also to be answered using an LLM. The LLM used for establishing a price indication can be the same as the LLM used for processing the user query and providing the response. Alternatively, the LLM used for generating a price indication can be a separate LLM or any other generative AI mechanism.

A price indication can be defined as the (estimated) cost for responding to a query and can comprise individual costs associated with each factor influencing the pricing. The price indication may also comprise a total estimated cost for a response. Alternatively, the price indication may be a combination of these approaches, in particular it can comprise the individual cost for each factor influencing the pricing and the total estimated cost for the response.

Allocation of a price, in particular the response price, may refer to the process of setting aside, e.g. in a digital wallet, an amount or value from a user that is equal to the amount of the price indication. An allocation process does not necessarily initiate a payment transfer. For instance, an actual payment may be carried out only when the allocated amount crosses a certain threshold. One advantage of the allocation is the reduced number of individual transactions and transaction fees when charging for generated responses.

One general advantage of the invention is that owing to the collected revenue, the overall performance of the service can be enhanced. For example, the revenue can be used to cover expenses related to hardware components, balance the overall system load and/or provide a scalable infrastructure that can meet increased user demands and improve responsiveness. Additionally, copyrighted material sources can be paid for and used in generating responses, potentially improving the quality of the responses.

Price indications for responses provided by the LLM are established using a pricing request that is sent to the LLM.

In one embodiment, generating the pricing request by the integrated control system may comprise:
using a pricing model template, and/or
using a natural language processing model, and/or
using a feedback mechanism, the feedback mechanism comprising:
   receiving user feedback associated with the response and/or the response price;
   storing the user feedback in a historian database;
   analyzing the user feedback, e.g. to identify most frequent user complaints; and
   adapting the pricing request based on the analyzed user feedback.

The pricing model template aims to provide a clear and well-defined framework for generating pricing requests. It is structured in a way that instructs or guides the LLM to generate a pricing model for a response to a user query.

In particular, the template may instruct the LLM to generate a pricing model based on provided criteria. The said criteria may include response performance indicators and/or data items.

The response performance indicators may refer to qualitative measures which are predominantly subjective and can include, but are not limited to, for example, usefulness, feasibility, clarity and relevance, scientific value, entertainment value, potential impact on the user, or any other qualitative measure based on which the quality of a response can be evaluated and a price indication can be provided accordingly.

The data items may refer to, in particular user data items, such as but not limited to age, gender, nationality, education, or any other data item that provides personal information about the user. The data items may also refer to, for example, data items extracted from or related to the user browsing and search history, social media, asset purchases, etc. The data items may also comprise, for instance, quantifiable data items, such as location, weather, time of day or any other quantifiable data item that may be relevant for generating a price for a response. In one embodiment, some of the data items, in particular user data items, may stem directly from the user. For example, the user may be requested by the platform to register a profile or account and provide personal information.

In an embodiment, some of the data items may be autonomously collected by the system, for instance device information or location. The system may also be provided with access to third-party cookies associated with the user which can be used to collect behavioral data items. In one embodiment, some of the data items may be received by the payment system. For instance, the payment system may store data about previous user purchases which can be analyzed to gain insight on user preferences. Furthermore, the system may collect data items from various digital content providers, particularly to collect data that is not user related.

According to one aspect of the invention, the method can assign and dynamically adjust weights to response performance indicators based on at least one data item. The advantage is that the method can consider the relative importance of response performance indicators with respect to, for instance, the location of the user, education or employment status, etc. In one embodiment, the method can dynamically adjust weights assigned to the response performance indicators based on any combination of data items. Therefore, a more important response performance indicator will be assigned a larger weight compared to a less important indicator. Response performance indicators that may not be considered significant, for instance, response performance indicators that have a weight below a certain threshold, will not be included as a parameter in the pricing request.

For example, a price indication provided by the LLM that is adjusted according to the location of the user, may take into account the cost of living in the specific location, thus providing an economically fairer access to the service. In another example, a price indication that is adjusted according to the education or employment status of the user enables to establish more personalized pricing strategies, such as offering discounts to users with lower or no income, hence making the service more affordable. Alternatively, adapting the weights with respect to any combination of user profile data items allows for a finer tuning of the importance of the indicators. In one embodiment, the weighting of the response performance indicators is performed using a neural network.

Adapting the pricing request based on data items may yield customized prices to the clients, which can potentially decrease churn rates and attract new users. In addition, considering that some data items are dynamically changing, the method is capable of capturing fluctuations in user behavior and adapting the pricing request accordingly. Another advantage, for example, is that analysis of previous purchases of a user can provide insights about the price a user is willing to pay for a particular service or product, thus allowing to adapt the pricing request in a way to maximize the revenue. The LLM can also be requested to take into consideration previous requests—the course of the communication—for determining an appropriate price indication.

The pricing model template can be based on a framework that commonly includes placeholders. The placeholders can take any value or variable, for instance age, location or any other attribute, criteria or characteristics relevant or important to the user, and can be selected in a way to provide a more personalized pricing request.

Providing a variable or a value to a placeholder may be performed automatically, for example using a programming function that inserts a variable or a value into a designated placeholder. In an alternative, the pricing model template can be automatically adapted using a natural language processing (NLP) model, for instance, a pre-trained NLP algorithm such as GPT, BERT (Bidirectional Encoder Representations from Transformers) or any other pre-trained model. Alternatively, the NLP model and/or algorithm can be trained on specific data sets relevant for generating a pricing request or rely on any type of data or rules, for example linguistics or statistical rules. To modify the pricing model template, the NLP model may be utilized to fill in each placeholder with the most contextually appropriate parameter from a plurality of highly relevant parameters.

To be able to improve the quality of the pricing request, the method further comprises a feedback mechanism that uses client feedback to refine the pricing request.

In one embodiment, the feedback mechanism can be incorporated as a rating system and users are invited to evaluate, on a predetermined scale, a single or various categories related to the quality of the response to their queries. As an example, the feedback mechanism may include criteria such as how useful or important the responses are according to the user or if the user finds the determined price indication appropriate for the response. Alternatively, the feedback mechanism can take the form of a survey containing open questions that enables users to provide a more detailed and/or personal feedback.

In general, the feedback mechanism can be incorporated in any manner suitable for receiving feedback that can be used to improve the generation of the pricing request.

The feedback can be stored in a historian database and analyzed to identify most frequent complaints based on which the pricing request should be modified.

To provide a user with a price for allocation, the method determines a response price. The response price represents the cost to be allocated for providing the response to a given query or input.

In particular, determining the response price can comprise at least one of the following:
calculating a total amount based on the price indication
establishing a response price range using the price indication

After determining the response price, the method can request a confirmation from the user to allocate the response price in order to provide the generated response.

In one embodiment, the method adopts also an ad-supported model and provides a request to the user to watch a video. If the user accepts to watch the video, the method can further provide several options to the user.

In particular, the method comprises the following steps:
sending a request to the user to watch a video;
determining whether the user has watched the video, when the user has watched the video:
reducing the response price by a specified amount and allocating the reduced price; and/or
allocating a credit to the user.

The credit allocated to a user may be stored in a digital wallet integrated, for example, in the payment system. In an embodiment, the credit may be used to pay a response price generated for a different response to a query. In an alternative, the credit may also be used to purchase assets from any asset provider that may recognize the credit as a valid payment currency.

This feature offers a higher flexibility to users with respect to their payment preferences and serves as an additional and reliable source of revenue to a platform utilizing this method step. Moreover, adopting an ad-supported model provides a technical advantage to the system, in particular regarding data collection and processing. Since ad-supported models routinely collect and analyze user data in order to improve their service, one technical advantage is that the system can gain on computational efficiency by directly implementing the user data already processed by the ad-supported model.

At least some of the above given problems are also solved by a computer readable medium. The computer readable medium stores instructions that when executed by at least one processor cause the at least one processor to implement one of the methods/embodiments as described above.

The object of the present invention is further solved by a system for providing response to a user query. The system comprises an integrated control system which is adapted to:
receive a user query from a user;
generate a pricing request based on the user query and/or parameters attached to the user;
transmit the pricing request to a large language model and request the large language model to generate a price indication, in particular a price;
receive the price indication generated by the large language model;
determine based on the price indication a response price;
request confirmation from the user to allocate the response price; and
transmit a response associated with the user query to the user.

Regarding the system, similar or identical benefits result as described in connection with the above methods.

### BRIEF DESCRIPTION OF THE DRAWINGS

In the following, embodiments of the invention are described with respect to the figures, wherein

FIG. 1 shows an a user, an integrated control system, a large language model server and a payment system that are connected through the internet,

FIG. 2 shows an illustrative diagram of a method for providing a response to a user query in accordance with the present invention,

FIG. 3 shows the components of the integrated control system, which is used to carry out the method for providing a response to a user query,

FIG. 4 shows an exemplary pricing request utilized to generate a price indication for a response to a user query.

### DETAILED DESCRIPTION

In the following description, same reference signs may be used for same parts and (different) parts with the same effect.

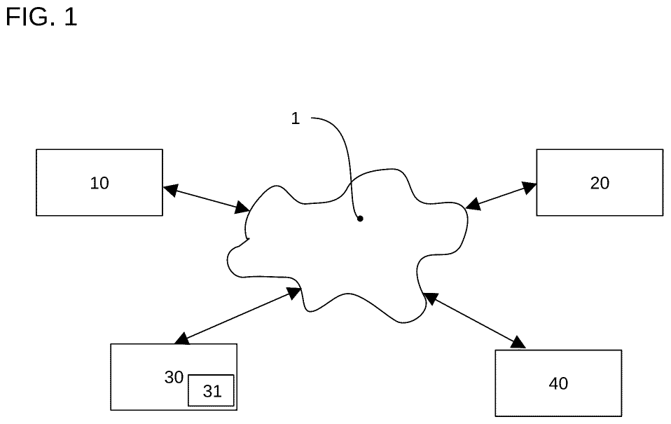

FIG. 1 shows a user 10, connected to an integrated control system 20 and a payment system 40, preferably for conducting micropayments, through the internet 1. The integrated control system 20 comprises a user interface that provides a seamless access for the user 10 to the integrated control system 20. The user 10 interacts with the integrated control system 20 through a client device, such as but not limited to a mobile, a PC or any other hardware device or component that is compatible with the integrated control system 20. The integrated control system 20 is also communicatively connected with a large language model server 30, hosting a large language model 31, and the payment system 40.

The integrated control system 20 can serve as a gateway to the large language model server 30 and the payment system 40. In an alternative, the payment system 40 can also directly communicate with the user 10.

The integrated control system 20 receives queries from the user 10, processes the queries and forwards the queries to the large language model 31 hosted on the large language model server 30. Accordingly, the integrated control system 20 receives responses from the large language model server 30, wherein the responses are generated by the large language model 31 and are related to the queries.

The integrated control system 20 may require the user to register an account for access. As part of the registering process, the integrated control system 20 may request the user to provide personal information, wherein the personal information refers to a data item or data items, such as age, bank information, educational status, etc. The personal information is collected, for instance using a questionnaire. Additionally, the integrated control system 20 may be capable of gathering information autonomously, for example by access to third-party cookies, resolving IP and/or MAC addresses, analyzing the type of software the user is using (what operating system is installed on the client device of the user 10) or by any other means for collecting information autonomously. The integrated control system 20 may also implement advanced security features, for instance two-factor or biometric authentication for providing secure access to its functionalities. Alternatively, the user may be registered with the payment system 40 and the integrated control system 20 may retrieve credentials for the user and/or personal information from the payment system 40.

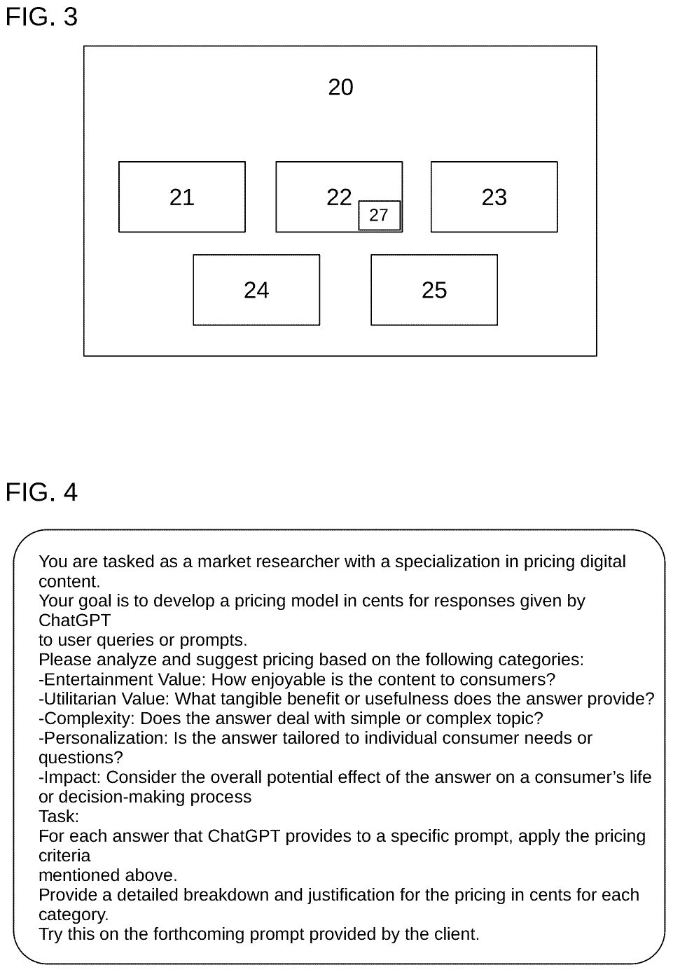

Whether or not the user is registered, the integrated control system 20 assigns a unique identification number (ID) to the user. The ID number is then stored in a general database 25 (see FIG. 3) together with other data, e.g. user credentials and personal information. The ID number is also provided to a historian database 24 (see FIG. 3), wherein the historian database 24 serves as a detailed historical repository for user activities, in particular interactions with the integrated control system 20 and/or the payment system 40. The ID number can be used as a common identifier for retrieving information about the user from the historian database 24 and the general database 25.

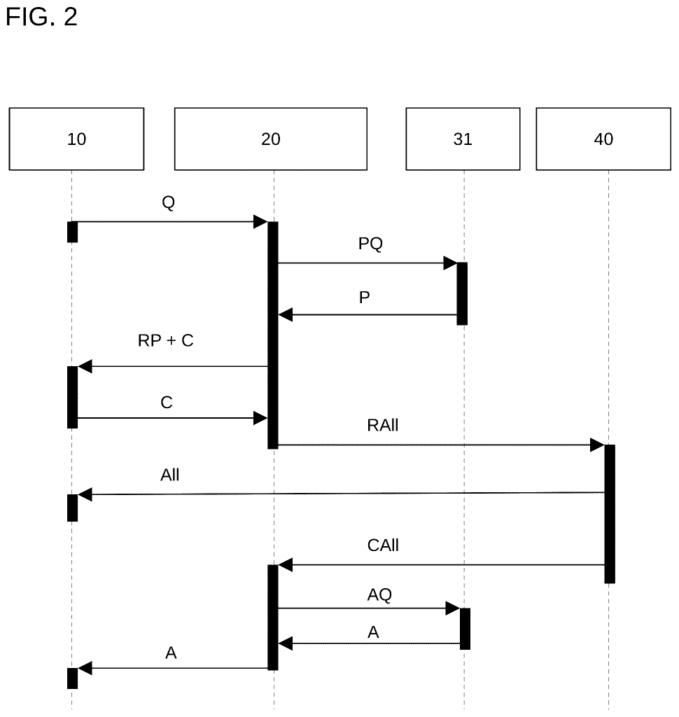

FIG. 2 shows an exemplary method according to the invention.

In an initial step, the integrated control system 20 receives a user query Q from the user 10 in the form of text, audio and/or video by means of a user interface.

The integrated control system 20 stores the user query Q in the historian database 24 of the integrated control system 20 and analyzes the user query Q to extract information from it. For instance, the integrated control system 20 may be capable of executing a natural language processing model, stored in a memory 22 (see FIG. 3), which performs semantic analyses on the user query Q for identifying personal information, preferences of a user or trends in the user's requests to the large language model 31. Additionally, the semantic analyses may be used to identify the underlying reason for or motivation behind the user query Q and adapt a pricing request PQ for the user query Q according to the specific intention of the user.

In one embodiment, the natural language processing model is provided as part of the integrated control system 20. In another embodiment, the natural language processing model is implemented in a separate component, wherein the separate component is communicatively connected with the integrated control system 20.

In one embodiment, the integrated control system 20 sends a request to the large language model 31 which instructs the large language model 31 to perform (semantic) analysis on the user query Q and to return the processed information to the integrated control system 20. In each embodiment, the extracted information is stored in the historian database 24 for the purpose of constructing a more detailed set of data for the user.

The integrated control system 20 then generates the pricing request PQ, typically in the form of text.

Upon generating the pricing request PQ, the integrated control system 20 transmits the pricing request PQ to the large language model 31 (see FIG. 2). The large language model 31 generates/initializes a pricing model, as instructed by the pricing request PQ.

In one embodiment, the pricing request PQ comprises the user query Q and the large language model 31 generates the pricing model using the information included in the user query Q. The information in the pricing request PQ can—in addition to the user query Q-contain criteria based on which the large language model 31 generates the pricing model. The criteria can include qualitative measures, for example, complexity, impact, personalization level, etc., and/or data related to the user such as age, nationality, location, etc.

The large language model 31 is adapted to interpret the user query Q and what information it inquires and assesses the user query Q based on the criteria provided in the pricing request PQ. For example, the pricing request PQ can request/instruct the large language model 31 to generate a pricing model for the user query Q ‘what is the capital of the United Kingdom?’ ‘assessing the complexity and usefulness’ (=performance indicator) and ‘considering that the user is a student’ (=background information=data item).

In a next step, the integrated control system 20 receives the pricing model—descriptive text describing the pricing model—and the price indication generated by the large language model 31 for the user query Q, wherein the price indication is particularly a price P, for example 10 Eurocents.

In one embodiment, the integrated control system 20 receives the price P in the form of individual prices for each criterion included in the pricing model. Continuing with the example above, the pricing model may establish the following price P for the user query Q ‘what is the capital of the United Kingdom?’:
complexity: 1 Eurocent
usefulness: 2 Eurocents

The integrated control system 20 processes the received price P and determines a response price RP. In one embodiment, the integrated control system 20 determines the response RP by calculating the total amount of the individual prices or it might just pass on the price as provided by the large language model 31, e.g. the 10 Eurocents as captioned above.

After generating the response price RP, the integrated control system 20 transmits the response price RP to the user 10 and requests a confirmation C for allocating the response price RP. For example, the integrated control system 20 may request the confirmation C and transmit the response price RP through a modal window that overlays the existing content, the modal window containing the response price RP and interactive buttons, such as ‘accept’ or ‘reject’ the allocation of the response price RP.

In a next step and in accordance with one embodiment of the invention, the integrated control system 20 receives the confirmation C from the user for allocating the response price RP. If the user rejects the allocation, e.g. by clicking on the ‘reject’ button, the integrated control system 20 may display a message, acknowledging the rejection and inviting the user to provide a new query. If the user accepts the allocation, the integrated control system 20 asks the payment system 40 to allocate the response price RP by transmitting a request for allocation RAll to the payment system 40. The request for allocation RAll can comprise the response price RP and/or the ID of the user and is constructed in a way that prompts the payment system 40 to initiate the allocation. For example, the request for allocation RAll can be an HTTP request sent to a dedicated API endpoint of the payment system 40. The request for allocation RAll can be provided in any format accepted by the payment system 40 and meeting the requirements of the payment system 40.

After the integrated control system 20 transmits the request for allocation RAll to the payment system 40, the payment system 40 allocates All the response price RP from the user.

In one embodiment, the payment system 40 initiates a payment transaction from the user only when the allocated response price RP exceeds a particular threshold. If the response price RP is below the threshold, the payment system 40 can store the response price RP, for example in a digital wallet (a dedicated database) and adds the response price RP to the response price RP provided for a different user query Q. The payment transaction is initiated when the accumulated amount exceeds the threshold.

After the payment system 40 allocates All the response price RP from the user, the integrated control system 20 receives a confirmation for allocation CAll from the payment system 40. For example, the integrated control system 20 can receive a notification by the payment system 40 every time the payment system 40 performs an allocation, the notification including the ID of the user

When the integrated control system 20 receives the confirmation for allocation CAll, it transmits a request AQ to the large language model 31 to provide a response A to the user query Q.

When the integrated control system 20 receives the response A from the large language model 31, the integrated control system 20 simply forwards the response A to the user 10 in one embodiment.

FIG. 3 shows individual components of the integrated control system 20. In the described embodiment, the integrated control system 20 has a processor 21 configured to execute instructions stored in a memory 22, a communication interface 23 allowing the integrated control system 20 to communicatively interact with the user 10, the large language model 31, hosted on the large language model server 30, and the payment system 40. Moreover, the integrated control system 20 has a historian database 24 and a general database 25 for storing data from the client device of the user 10, the large language model 31 and the payment system 40.

The memory 22 stores a set of instructions for implementing a process control algorithm 27. When executed by the processor 21, the process control algorithm 27 carries method as described in connection with FIG. 2.

In one embodiment of the invention, the historian database 24 and the general database 25 are dedicated blocks of the integrated control system 20, which store data utilized in the generation of the pricing request PQ.

In one embodiment, the historian database 24 and the general database 25 can be cloud databases and one of the steps of the process control algorithm 27 is to transmit and receive data for a user to and from the cloud databases, for instance using APIs.

In one embodiment, the historian database 24 receives and stores data also from the payment system 40, wherein the data is related to previous purchases made by the user. The data may be received from the payment system 40, for instance after every purchase made by the user.

FIG. 4 shows an exemplary pricing request PQ for generating a pricing model by the large language model 31.

In this example, the pricing request PQ comprises the user query Q and guides the large language model 31 to generate a pricing model based on the user query Q and qualitative measures, namely entertainment value, utilitarian value, complexity, personalization and impact to the user (in this application also referred to as performance indicators).

The exemplary pricing request PQ provided is the following:
“You are tasked as a market researcher with a specialization in pricing digital content. Your goal is to develop a pricing model in cents for responses given by ChatGPT to user queries or prompts.

Please analyze and suggest pricing based on the following categories:
Entertainment Value: How enjoyable is the content to consumers?
Utilitarian Value: What tangible benefit or usefulness does the answer provide?
Complexity: Does the answer deal with simple or complex topic?
Personalization: Is the answer tailored to individual consumer needs or questions?
Impact: Consider the overall potential effect of the answer on a consumer's life or decision-making process

### Task:

For each answer that ChatGPT provides to a specific query or prompt, apply the pricing criteria mentioned above.

Provide a detailed breakdown and justification for the pricing in cents for each category.

When you develop the pricing model as requested, apply the pricing model to the query ‘What is the climate like in Antarctica?’.”

In response to the exemplary pricing request PQ, the large language model 31 generates a pricing model and applies the pricing model to the user query Q. The pricing model is summarized below:

### “Entertainment Value:

High Entertainment Value (e.g., creative, humorous, engaging): 15 cents
Moderate Entertainment Value (e.g., informative and engaging): 10 cents
Entertainment Value (e.g., purely informative): 5 cents

### Utilitarian Value:

High Utilitarian Value (e.g., actionable advice, solutions): 20 cents
Moderate Utilitarian Value (e.g., informative but not highly actionable): 10 cents
Low Utilitarian Value (e.g., general information): 5 cents

### Complexity:

High Complexity (e.g., detailed explanations on intricate topics): 15 cents
Moderate Complexity (e.g., covering a broad topic with some depth): 10 cents
Low Complexity (e.g., straightforward and simple information): 5 cents

### Personalization:

High Personalization (e.g., tailored to user's specific needs): 20 cents
Moderate Personalization (addresses the query but not highly tailored): 10 cents
Low Personalization (e.g., generic information): 5 cents

### Impact:

High Impact (e.g., potentially life-changing advice): 25 cents
Moderate Impact (e.g., influencing decision making): 15 cents
Low impact (e.g., general information with minimal influence): 5 cents
   Applying the Pricing Model to the Query ‘What is the climate like in Antarctica?’:
Entertainment Value: Low (5 cents)—as the query is focused on factual information
Utilitarian Value: Moderate (10 cents)—providing valuable information about the climate.
Complexity: Moderate (10 cents)—requiring a degree of detail in explaining the climate.
Personalization: Low (5 cents)—the answer is not highly tailored to individual needs.
Impact: Low (5 cents)—general information with minimal influence.”

In one embodiment, the pricing request PQ does not include the user query Q and the integrated control system 20 transmits the user query Q to the large language model 31 after transmitting the pricing request PQ. In one embodiment, the integrated control system 20 may only transmit a summary of the original user query Q, e.g. ‘Assuming you would be asked about . . . , please provide a pricing model taking into consideration . . . ’.

In one embodiment, the integrated control system 20 hosts the large language model 31. In particular, the integrated control system 20 stores the large language model 31 in the memory 22.

In one embodiment, the integrated control system 20 transmits the response price RP and can request the user to watch a video. For example, the integrated control system 20 can implement additional interactive button to the modal window that provides the response price RP and the request for confirmation C, the additional button for example being ‘watch video’.

In one embodiment, if the user opts to watch the video, in particular by clicking on the ‘watch video’ button, the integrated control system 20 executes a dedicated method step from the process control algorithm 27 for reducing the response price RP by a particular amount and then requests confirmation C for allocating the reduced price. For example, after reducing the response price RP, the integrated control system 20 can update the modal window to include the reduced price and the buttons ‘accept’ and ‘reject’ for confirming C the allocation of the reduced price.

In one embodiment, if the user opts to watch the video, the integrated control system 20 allocates a credit to the user and still requests the confirmation C for allocating the response price RP. The allocated credit can be stored in the integrated system 20, e.g. in the historian database 24, or, alternatively, can be transmitted to the payment system 40 for storing in the digital wallet. The credit can be utilized by the user to pay for other responses or to purchase assets by asset providers that accept the payment method or payment currency.

In one embodiment, the confirmation C for allocation provided by the user is received directly by the payment system 40. In turn, the payment system 40 performs the step of allocating All the response price RP, or alternatively the reduced price, and confirms the allocation CAll to the integrated system 20.

In one embodiment, the integrated control system 20 receives the response A to the user query Q together with receiving the pricing model and the price indication. For example, the pricing request PQ may additionally include instructions for the large language model 31 to generate the response A for the user query Q. Consequently, the method step AQ requesting the response A to the user query Q and the following method step of receiving the response A are excluded.

For ease of understanding, the exemplary integrated control system 20 has been described as communicating with a single large language model 31 implemented on the large language model server 30 in FIG. 1. However, it should be understood that it is possible for the integrated control system 20 to communicate with at least one first large language model that is a specialized large language model trained with data for generating the price indication and/or the response price RP for a response to the user query Q; and at least one second large language model that is a general and/or specialized large language model for generating the response to the query Q upon the integrated control system 20 receiving the confirmation C for allocation of the response price RP.

At this point, it should be noted that all of the parts described above are claimed to be relevant to the invention when considered alone and in any combination, especially of the details shown in the drawings.

### REFERENCE SIGNS

10 user
20 integrated control system
21 processor
22 memory
23 communication interface
24 historian database
25 general database
30 LLM Server
31 large language model (LLM)
40 payment system
Q query
PQ pricing request
P price
RP response price
C confirmation
A response
RAll request for allocation
Call confirmation for allocation
All allocation

The invention claimed is:

1. A system for providing response to a user query, the system comprising:
an integrated control system, said integrated control system comprising:
a processor,
a memory,
a communication interface adapted to communicate with a network, and
at least one database,
wherein the memory, communication interface and at least one database are each in communication with the processor; and
wherein the integrated control system is adapted to:
receive a user query from a user;
generate a pricing request based on the user query and/or parameters attached to the user;
transmit the pricing request to a first large language model and request the large first language model to generate a price indication;
receive the price indication generated by the first large language model;
determine based on the price indication a response price;
request confirmation from the user to allocate the response price; and
transmit a response associated with the user query to the user.

2. The system according to claim 1, wherein the at least one database includes at least a historian database and a general database.

3. The system according to claim 1 wherein the integrated control system is adapted to receive the response from a second large language model adapted for generating the response indication.

4. The system according to claim 3, wherein the first and second large language models are different large language models.

5. The system according to claim 3, wherein the first and second large language models are the same large language models.

6. A computer-implemented method for an integrated control system for a providing response to a user query, the method comprising the steps of:
receiving a user query from a user by an integrated control system;
generating a pricing request based on the user query and/or parameters attached to the user;
transmitting the pricing request to a first large language model, wherein the integrated control system requests the first large language model to generate a price indication;
receiving by the integrated control system the price indication generated by the first large language model;
determining based on the price indication a response price;
requesting confirmation from the user to allocate the response price;
receiving by the integrated control system a confirmation to allocate the response price;
allocating the response price using a payment system;
transmitting a response associated with the user query to the user.

7. The method of claim 6, wherein the request for confirmation to allocate the response price comprises the response price.

8. The method of claim 6, wherein generating the pricing request comprises the steps of:
using a pricing model template; and/or
using a natural language processing mode; and/or
using a feedback mechanism, the feedback mechanism comprising:
receiving user feedback associated with the response and/or the response price;
storing the user feedback in a historian database;
analyzing the user feedback, e.g. to identify most frequent user complaints;
adapting the pricing request based on the analyzed user feedback.

9. The method of claim 8, wherein the pricing model template comprises at least one placeholder, wherein the at least one placeholder is assigned at least one response performance indicator or at least one user profile data item.

10. The method according to claim 6, wherein at least one response performance indicator is provided to the first large language model, wherein the pricing request causes the first large language model to generate the price indication based on the at least one response performance indicator.

11. The method according to claim 6, wherein at least one user profile data item is provided to the first large language model as part of the pricing request, wherein the pricing request causes the first large language model to generate the price indication based on the at least one user profile data item.

12. The method according to claim 6, further comprising the steps of:
assigning and/or adjusting a weight for at least one response performance indicator by the integrated control system based on at least one user profile data item, and
forwarding the weight to the first large language model for use generating the price indication.

13. The method according to claim 12, wherein the assigning and/or adjusting of weights is performed using a neural network.

14. The method according to claim 6, wherein determining the response price comprises the steps of:
calculating a total amount based on the price indication,
establishing a response price range using the price indication.

15. The method according to claim 6, wherein the step of allocating the response price comprises the steps of:
transmitting a request for allocation by the integrated control system to the payment system;
receiving by the integrated control system a confirmation for the allocation from the payment system and/or from the user.

16. The method according to claim 6, wherein the step of allocating the response price comprises the steps of:
transmitting from the payment system to the user a request to allocate the response price;
receiving by the payment system confirmation from the user to allocate the response price;
allocating by the payment system the response price.

17. The method of according to claim 6, further comprising the steps of:
sending a request to the user to watch a video,
determining whether the user has watched the video, when the user has watched the video:
reducing the response price by a specified amount and allocating the reduced price; and/or allocating a credit to the user.

18. The method according to claim 17, wherein the payment system comprises a digital wallet for allocating the credit.

19. The method according to claim 6, further comprising the steps of:
transmitting a request to a second large language model to generate a response to the user query after the response price has been allocated, wherein the second large language model is adapted for generating the response; and
receiving from the second large language model a response to the user query.

20. The method according to claim 19, wherein the first and second large language models are different large language models.

21. The method according to claim 19, wherein the first and second large language models are the same large language models.

22. A system for providing response to a user query, the system comprising an integrated control system, wherein the integrated control system is adapted to:
receive a user query from a user;
generate a pricing request based on the user query and/or parameters associated with the user;
transmit the pricing request to a first large language model and request the large language model to generate a price indication;
receive the price indication generated by the first large language model;
determine based on the price indication a response price;
request confirmation from the user to allocate the response price; and
transmit a response associated with the user query to the user.

23. The system according to claim 22 wherein the integrated control system is adapted to receive the response from a second large language model adapted for generating the response.

24. The system according to claim 23, wherein the first and second large language models are different large language models.

25. The system according to claim 23, wherein the first and second large language models are the same large language models.
